(19) United States
(12) Patent Application Publication
(10) Pub. No.: US 2004/0114342 A1
(43) Pub. Date: Jun. 17, 2004

(54) Planar lighting structure

(75) Inventors: Ching-Huang Lin, Ma-Gong City (TW); Che-Kuei Mai, Hsinchu (TW)

Correspondence Address: LOWE HAUPTMAN GOPSTEIN GILMAN & BERNER, LLP, 1700 Diagonal Road, Suite 310, Alexandria, VA, 22314, US

(73) Assignee: Toppoly Optoelectronics Corp.

(21) Appl. No.: 10/316,884

(22) Filed: Dec. 12, 2002

(51) Int. Cl. F21V 7/04

(52) U.S. Cl. 362/31; 362/26; 362/236; 362/237

(57) ABSTRACT

This invention provides a planar lighting structure having a light guide plate with inverted V pattern constituted by two wedge light guide plate in order to increase illumination of the planar lighting structure.

### BACKGROUND OF THE INVENTION

1. Field of the Invention

The present invention generally relates to a planar lighting structure, and more particularly to a planar lighting structure with a light guide plate with inverted V pattern constituted by two wedge light guide plate.

2. Description of the Prior Art

Many display devices need plane light sources such as LCD monitors and scanners. It is well known to use an incandescent lamp or LED as a point light source or a cold cathode fluorescent lamp (CCFL) as a line light source. There are two direct methods to form a plane light source, one is to assemble an array of the above-mentioned point light source, and the other is to assemble a row of the above-mentioned line light source. However, such methods will not only waste the power supply, but also be detrimental to the cost reduction.

It is advantage to form a plane light source by using a light guide plate such as the wedge plate 10 shown in FIG. 1A or the flat plate 20 shown in FIG. 1B. These light guide plates can guide the light rays emitted from the light sources 12,22 toward the liquid crystal cell array (not shown in these figures) through reflecting slant portions (V-cut) or convex/concave dots. Presently, there are many improvements on the wedge light guide plate 10 in FIG. 1A, such as US patent publication number 20020005991, which enhances the uniformity by putting a prism sheet above the light guide plate to avoid light rays emitted directly into the eyes of user from the light source.

However, there are still some drawbacks in above two methods for forming plane light sources. First, as shown in the wedge plate 10 in FIG. 1A, illumination of the light source 12 is usually focused at the position that is about one-third length of the light guide plate close to the light source 12. It causes the problem that light rays are not well distributed for the left and right sides of wedge light guide plate 10. Besides, as shown in FIG. 1B, to use the flat guide plate 20 with two light sources 22 can decrease the above-mentioned problem but the illumination at the midst of flat guide plate 20 is darkest.

Another method for resolving the problem that light rays are not well distributed as shown in FIG. 2, provided by Fujitsu, is to use the hollow structure of light guide plate. The light rays are emitted from the light sources 30 at both lateral sides of light guide plate into the panel of LCD monitor through the lens 32, two pieces of lens 34 with specified reflection index, two pieces of control sheets 36 with specified refraction index, and the lens set 38. Besides, two reflection sheets 40 can be affixed on the bottom of two pieces of lens 34 in order to increase illumination. However, this complex planar lighting structure not only increases the cost and the difficulty of production, but also reduces the yield of production.

### SUMMARY OF THE INVENTION

In the light of the state of the art described above, it is an object of the present invention to provide a planar lighting structure with connected wedge light guide plates which is immune to the problems of the conventional planar lighting structure described above and which can increase illumination of the planar lighting structure and make the light rays emitted from wedge light guide plates to be well distributed.

It is also an object of this invention to reduce the weight of planar lighting module.

It is another object of this invention to increase the life cycle of planar lighting module.

In view of the above and other objects which will become apparent as the description proceeds, there is provided according to a general aspect of the present invention a planar lighting structure which comprises a first light source; a first wedge light guide plate having a first light-transmissive surface that can guide substantially vertically the light rays emitted from the first light source at one lateral end of the first wedge light guide plate toward a light-emitting surface; a second wedge light guide plate having a second light-transmissive surface; and a second light source at one lateral end of the second wedge light guide plate, wherein the light rays emitted from the second light source are guided substantially vertically toward the light-emitting surface by the second light-transmissive surface, and the other lateral end of the second light guide plates is connected with the other lateral end of the first light guide plate.

Base on the idea described above, wherein the first and second light-transmissive surfaces are fully inclined planes.

Base on the aforementioned idea, wherein the first and second light-transmissive surfaces are curved surfaces.

Base on the idea described above, wherein parts of the first and second light-transmissive surfaces are curved surfaces and other parts are inclined planes.

Base on the aforementioned idea, wherein the length of inclined planes is about one-third length of the first and second light-transmissive surfaces.

Base on the idea described above, wherein there are a plurality of slanted portions (V-cuts) on the first and second light-transmissive surfaces.

Base on the aforementioned idea, wherein there are convex/concave dots on the first and second light-transmissive surfaces.

Base on the idea described above, wherein the planar lighting structure is used as a back light source.

Base on the aforementioned idea, the planar lighting structure further including a reflector on the opposite surface of the light-emitting surface.

Base on the idea described above, the planar lighting structure further including a diffusor sheet on the light-emitting surface.

Base on the aforementioned idea, the planar lighting structure further including a prism sheet on the light-emitting surface.

Base on the idea described above, wherein the planar lighting structure is used as a front light source.

Base on the aforementioned idea, wherein the first and second light sources are selected from the group consisting of CCFL (cold cathode fluorescent lamp) and LED (light emitting diode).

There is provided according to a general aspect of the present invention a planar lighting structure which comprises two light sources; and a light guide plate having a light-transmissive surface with inverted V pattern that can guide substantially vertically the light rays emitted from two light sources at two lateral ends of the light guide plate toward a light-emitting surface.

Base on the idea described above, wherein the light-transmissive surface with inverted V pattern is a fully inclined plane.

Base on the aforementioned idea, wherein the light-transmissive surface with inverted V pattern is an arc surface.

Base on the idea described above, wherein parts of the light-transmissive surface with inverted V pattern are arc surfaces and other parts are inclined planes.

Base on the aforementioned idea, wherein the length of inclined planes is about one-third length of the light-transmissive surface with inverted V pattern.

Base on the idea described above, wherein there are a plurality of slanted portions (V-cuts) on the light-transmissive surface with inverted V pattern.

Base on the aforementioned idea, wherein there are convex/concave dots on the light-transmissive surface with inverted V pattern.

Base on the idea described above, wherein the planar lighting structure is used as a back light source.

Base on the aforementioned idea, the planar lighting structure further including a reflector on the opposite surface of the light-emitting surface.

Base on the idea described above, the planar lighting structure further including a diffusor sheet on the light-emitting surface.

Base on the aforementioned idea, the planar lighting structure further including a prism sheet on said light-emitting surface.

Base on the idea described above, wherein the planar lighting structure is used as a front light source.

Base on the aforementioned idea, wherein two light sources are selected from the group consisting of CCFL (cold cathode fluorescent lamp) and LED (light emitting diode).

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A illustrates a conventional planar lighting structure with wedge light guide plate;

FIG. 1B illustrates a conventional planar lighting structure with plat light guide plate;

FIG. 2 illustrates a conventional planar lighting structure with hollow light guide plate provided by Fujitsu;

FIG. 3 illustrates the first preferred embodiment of connected wedge light guide plates according to the present invention;

FIG. 4 illustrates the second preferred embodiment of connected wedge light guide plates according to the present invention; and

FIG. 5 illustrates the third preferred embodiment of connected wedge light guide plates according to the present invention.

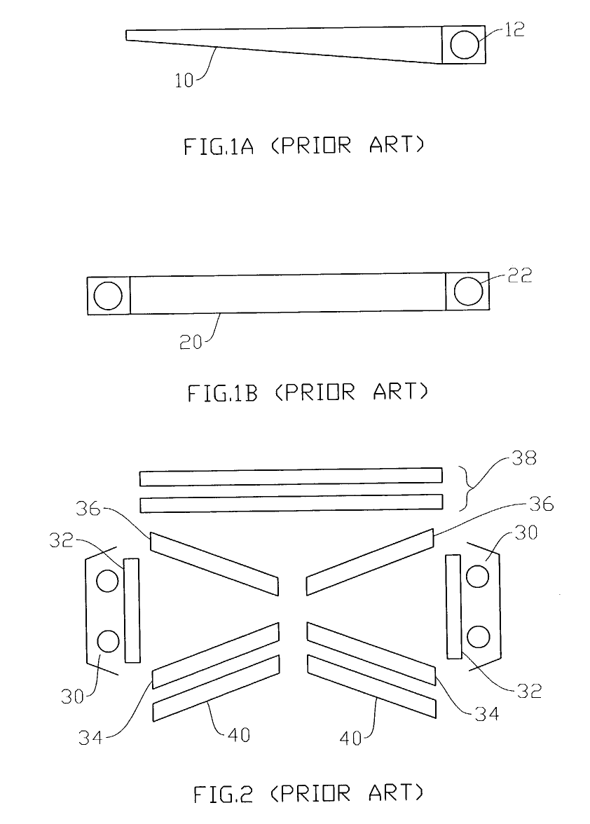

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

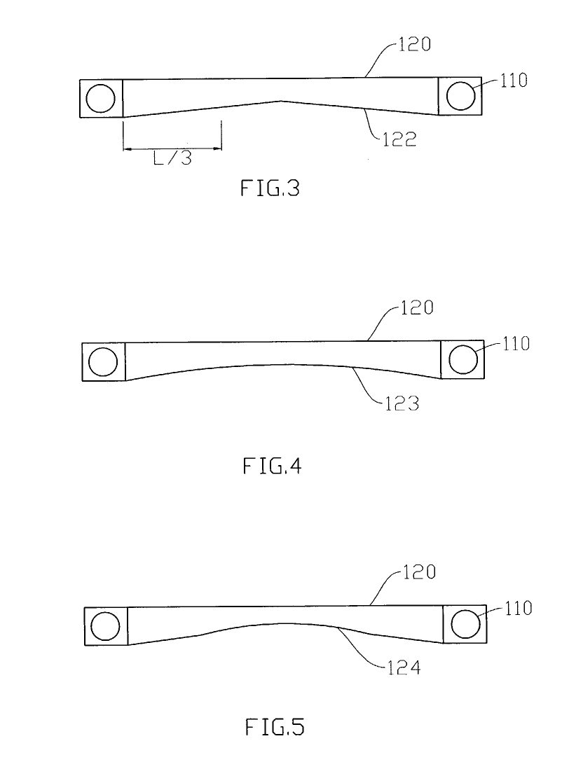

Next, a planar lighting structure is illustrated according to this invention. Please refer to FIG. 3, two wedge light guide plates 120 are connected each other so that the light-transmissive surface, which is the lower surface of connected wedge light guide plates 120 form a light-transmissive surface with inverted V pattern 122. Two light sources 110 are separately put at two lateral ends of the connected wedge light guide plates 120. The light sources 110 can be constituted by CCFLs (cold cathode fluorescent lamp) or LEDs (light emitting diode). There are convex/concave dots or a plurality of slanted portions (V-cuts) on the light-transmissive surface with inverted V pattern 122. Similarly, there can be convex/concave dots or a plurality of slanted portions (V-cuts) on the light-emitting surface, which is the upper surface of connected light guide plates 120, too. The planar lighting structure according to the present invention can be used as a front light source or back light source of liquid crystal display (LCD) device. It is a reflective-type LCD while the planar lighting structure is as a front light source, and it is a transmissive-type LCD while the planar lighting structure is as a back light source. The light-transmissive surface with inverted V pattern 122 can be a fully inclined plane. The light rays emitted from connected light guide plates 120 are well distributed when a diffusor sheet or/and a prism sheet is put on the light-emitting surface of connected light guide plates 120. A reflector can be put on the opposite surface of light-emitting surface for reflecting up the light rays.

It is another preferred embodiment according to the present invention as shown in FIG. 4. The light-transmissive surface with inverted V pattern 123 is a curved surface or arc surface for improving the illumination at the midst of connected wedge light guide plates 120 because reflective and refractive conditions of the curved/arc surface and the inclined plane are different.

FIG. 5 is the third embodiment of connected wedge light guide plates according to the present invention. The geometrical pattern of light-transmissive surface with inverted V pattern 124 is combination of fully inclined plane and curved/arc surface. The light rays are well distributed for parts of the light-transmissive surface close to light sources 110 are fully inclined planes and the illumination is better for other parts at the midst of connected wedge light guide plates 120 are curved/arc surfaces. A preferred embodiment is used that both about one-third length of connected wedge light guide plates close to light sources 110 are fully inclined planes and other parts are curved/arc surfaces

There are many advantages to connect two wedge light guide plates. First, the light rays emitted from the light-emitting surface of connected wedge light guide plates are well distributed and the illumination of planar lighting structure is increased while the light-transmissive surface of connected wedge light guide plates is chosen from inclined plane, curved/arc surface or both. Next, the life cycle of planar lighting module is increased because the illumination and uniformity of light source are improved. Besides, the weight of planar lighting module can be reduced as compare with conventional plat guide plate.

Although specific embodiments have been illustrated and described, it will be obvious to those skilled in the art that various modifications may be made without departing from what is intended to be limited solely by the appended claims.

What is claimed is:

1. A planar lighting structure, comprising:
a first light source;
a first wedge light guide plate having a first light-transmissive surface that can guide substantially vertically the light rays emitted from said first light source at one lateral end of said first wedge light guide plate toward a light-emitting surface;
a second wedge light guide plate having a second light-transmissive surface; and
a second light source at one lateral end of said second wedge light guide plate, wherein the light rays emitted from said second light source are guided substantially vertically toward said light-emitting surface by said second light-transmissive surface, and the other lateral end of said second light guide plates is connected with the other lateral end of said first light guide plate.

2. The planar lighting structure according to claim 1, wherein said first and second light-transmissive surfaces are fully inclined planes.

3. The planar lighting structure according to claim 1, wherein said first and second light-transmissive surfaces are curved surfaces.

4. The planar lighting structure according to claim 1, wherein parts of said first and second light-transmissive surfaces are curved surfaces and other parts are inclined planes.

5. The planar lighting structure according to claim 4, wherein the length of inclined planes is about one-third length of said first and second light-transmissive surfaces.

6. The planar lighting structure according to claim 1, wherein there are a plurality of slanted portions (V-cuts) on said first and second light-transmissive surfaces.

7. The planar lighting structure according to claim 1, wherein there are convex/concave dots on said first and second light-transmissive surfaces.

8. The planar lighting structure according to claim 1, wherein said planar lighting structure is used as a back light source.

9. The planar lighting structure according to claim 8 further including a reflector on the opposite surface of said light-emitting surface.

10. The planar lighting structure according to claim 8 further including a diffusor sheet on said light-emitting surface.

11. The planar lighting structure according to claim 8 further including a prism sheet on said light-emitting surface.

12. The planar lighting structure according to claim 1, wherein said planar lighting structure is used as a front light source.

13. The planar lighting structure according to claim 1, wherein said first and second light sources are selected from the group consisting of CCFL (cold cathode fluorescent lamp) and LED (light emitting diode).

14. A planar lighting structure, comprising:
two light sources; and
a light guide plate having a light-transmissive surface with inverted V pattern that can guide substantially vertically the light rays emitted from said two light sources at two lateral ends of said light guide plate toward a light-emitting surface.

15. The planar lighting structure according to claim 14, wherein said light-transmissive surface with inverted V pattern is a fully inclined plane.

16. The planar lighting structure according to claim 14, wherein said light-transmissive surface with inverted V pattern is an arc surface.

17. The planar lighting structure according to claim 14, wherein parts of said light-transmissive surface with inverted V pattern are arc surfaces and other parts are inclined planes.

18. The planar lighting structure according to claim 17, wherein the length of inclined planes is about one-third length of said light-transmissive surface with inverted V pattern.

19. The planar lighting structure according to claim 14, wherein there are a plurality of slanted portions (V-cuts) on said light-transmissive surface with inverted V pattern.

20. The planar lighting structure according to claim 14, wherein there are convex/concave dots on said light-transmissive surface with inverted V pattern.

21. The planar lighting structure according to claim 14, wherein said planar lighting structure is used as a back light source.

22. The planar lighting structure according to claim 21 further including a reflector on the opposite surface of said light-emitting surface.

23. The planar lighting structure according to claim 21 further including a diffusor sheet on said light-emitting surface.

24. The planar lighting structure according to claim 21 further including a prism sheet on said light-emitting surface.

25. The planar lighting structure according to claim 14, wherein said planar lighting structure is used as a front light source.

26. The planar lighting structure according to claim 14, wherein said two light sources are selected from the group consisting of CCFL (cold cathode fluorescent lamp) and LED (light emitting diode).
